(19) United States
(12) Patent Application Publication
(10) Pub. No.: US 2024/0011391 A1
(43) Pub. Date: Jan. 11, 2024

(54) METHOD FOR DETERMINING AN ELECTROFACIES INTERPRETATION OF MEASUREMENTS CARRIED OUT IN A WELL

(71) Applicant: IFP Energies nouvelles, RUEIL-MALMAISON (FR)

(72) Inventors: Patrick RASOLOFOSAON, RUEIL-MALMAISON CEDEX (FR); Antoine BOUZIAT, RUEIL-MALMAISON CEDEX (FR); Francois COKELAER, RUEIL-MALMAISON CEDEX (FR)

(21) Appl. No.: 18/042,059

(22) PCT Filed: Aug. 10, 2021
(86) PCT No.: PCT/EP2021/072277

§ 371 Date: Feb. 17, 2023

(30) Foreign Application Priority Data
Aug. 24, 2020 (FR) FR2008646

(51) Int. Cl. E21B 47/04; E21B 49/08; G01V 1/40

(52) U.S. Cl. CPC E21B 47/04; E21B 49/088; G01V 1/40

(57) ABSTRACT

The invention is a method of determining an electrofacies interpretation of measurements relative to at least a portion of at least one well drilled through an underground formation. The method comprises applying supervised or unsupervised classification methods to measurements in order to determine learning information. Supervised classification methods are subsequently applied to the measurements, the classification methods being trained by learning information. An ensemble classification method is then applied to the results of the supervised classification methods to determine the electrofacies interpretation of the measurements.

### CROSS REFERENCE TO RELATED APPLICATIONS

Reference is made to International Application No. PCT/EP2021/072277, filed Aug. 10, 2021, and French Application No. 20/08.646 filed Aug. 24, 2020, which are incorporated herein by reference in their entirety.

### BACKGROUND OF THE INVENTION

### Field of the Invention

The present invention concerns the interpretation of measurements performed in a well drilled through an underground formation, such as logging measurements performed along a well.

The invention can apply, by way of non-limitative example, petroleum exploration and exploitation, underground formation characterization for geological storage of a fluid such as CO2, monitoring of a geological fluid storage site, and geothermal energy or subsurface energy storage. More generally, the invention can apply to any field involving a step of geological characterization of an underground formation.

### Description of the Prior Art

In general, exploration and exploitation of geological oil reservoirs requires knowledge of the underground geology to be precise as possible to efficiently provide reserves evaluation, production modelling or exploitation management. Indeed, determining the location of at least one of a production well and an injection well within a hydrocarbon reservoir, the drilling mud composition, the completion characteristics, selection of a hydrocarbon recovery method (such as waterflooding for example) and of the parameters required for implementing this method (such as injection pressure, production flow rate, etc.) requires good knowledge of the reservoir. Reservoir knowledge notably is an accurate a description as possible of the structure, the petrophysical properties, the fluid properties, etc., of the reservoir studied.

To acquire such knowledge, the petroleum industry combines field measurements (performed in situ, during seismic surveys, logging measurements, core drilling, etc.) with experimental modelling (performed in the laboratory) and numerical simulations (using softwares). Formalization of this knowledge then involves establishing a model of the subsoil, represented on a computer in form of a grid representation which is referred to as geological model.

This geological model can notably be used (after upscaling) in a flow simulation (or reservoir simulation) to predict (or simulate) flows, the evolution of pressures in the reservoir and the fluid production of wells drilled through the reservoir. It is clear that the prediction of a flow simulation is all the more representative of the reality of flows in the underground formation of interest when the geological model of the underground formation is precise. Well logs and analysis of the core samples taken in wells allowing precise local data to be acquired on the rocks traversed by a well are particularly sought after for the construction of a reliable geological model.

Well logging measures, using sondes, the characteristics of rocks traversed by a well. A logging measurement provides a record as a function of depth (or along a characteristic of a geological formation traversed by a well). Examples of such well logs are gamma ray logs, sonic logs, density logs, electric logs or well image logs.

The records resulting from well logging operations are subsequently analysed and interpreted, most often jointly, in order to deduce rock characteristics therefrom. This interpretation notably involves looking, along these records, for intervals (i.e. successive sample sets) with similar characteristics. These intervals for which the characteristics are coherent from one sample to another are referred to as electrofacies.

In general, interpretation of at least part of the logging measurements is carried out by an expert, who performs a cross analysis of the various log types. The result of such an interpretation is therefore subjective and it may vary widely from one interpreter to another. Such a manual process can be long and tedious, and it cannot reasonably be envisaged for all the well logs. However, the quality of a human interpretation of well logs is often higher than that of fully automated computer-implemented interpretations.

The following documents are mentioned in the rest of the description:
Serra O, Abbott HT (1980), The Contribution of Logging Data to Sedimentology and Stratigraphy. In: SPE 9270, 55th Technical Conference, Dallas, TX, 19 pp.
Dubois, M. K., Bohling, G. C., & Chakrabarti, S. (2007), Comparison of Four Approaches to a Rock Facies Classification Problem. Computers & Geosciences, 33(5), 599-617.
J. C. Dunn (1973), A Fuzzy Relative of the ISODATA Process and Its Use in Detecting Compact Well-Separated Clusters, Journal of Cybernetics 3: 32-57.
Emelyanova, I., Pervukhina, M., Clennell, M., & Dyt, C. (2017, June), Unsupervised Identification of Electrofacies Employing Machine Learning. In 79th EAGE Conference and Exhibition 2017-Workshops (pp. cp-519), European Association of Geoscientists & Engineers.
Ch. Fraley and A. E. Raftery (2002), Model-Based Clustering, Discriminant Analysis, and Density Estimation, Journal of the American Statistical Association 97:611:631.
Chris Fraley, A. E. Raftery, T. B. Murphy and L. Scrucca (2012), mclust Version 4 for R: Normal Mixture Modeling for Model-Based Clustering, Classification, and Density Estimation, Technical Report No. 597, Department of Statistics, University of Washington.
Gan, G., Ma, C., & Wu, J. (2007), Data Clustering: Theory, Algorithms, and Applications (Vol. 20). Siam.
Genuer, R., & Poggi, J. M. (2018). Chapter 8: Arbres CART et Forêts aléatoires,
Importance et selection de variables, M.-B. Myriam, SG, & TAC (Eds.), Apprentissage Statistique et Données Massives, 295-342.
Halotel, J., Demyanov, V., & Gardiner, A. (2020), Value of Geologically Derived Features in Machine Learning Facies Classification, Mathematical Geosciences, 52(1), 5-29.
Ho, T. K. (1995). Random decision forests, In Proceedings of 3rd international Conference on Document Analysis and Recognition (Vol. 1, pp. 278-282). IEEE.
Jeong, J., Park, E., Emelyanova, I., Pervukhina, M., Esteban, L., & Yun, S. T. (2020), Interpreting the Subsurface Lithofacies at High Lithological Resolution by Integrating Information from Well-Log Data and Rock-Core Digital Images, Journal of Geophysical Research: Solid Earth, 125(2), e2019JB018204.
Niculescu-Mizil, A., & Caruana, R. (2005, August), Predicting Good Probabilities with Supervised Learning, In Proceedings of the 22nd international conference on Machine learning (pp. 625-632).
Seni, G., & Elder, J. F. (2010). Ensemble methods in data mining: improving accuracy through combining predictions, Synthesis Lectures on Data Mining and Knowledge Discovery, 2(1), 1-126.

Among the computer-implemented methods for electrofacies interpretation of measurements performed in wells, a distinction is conventionally made between fully automated methods, involving unsupervised classification methods, and partly automated methods involving supervised classification methods. Unlike an unsupervised classification method, a supervised classification method aims to group samples into homogeneous classes by taking account of predefined rules determined from learning information. It is typical in the prior art that the learning information required by supervised classification methods results from an interpretation, manually performed by an expert (therefore referred to as semi-automated method), of at least one log data subset. An electrofacies interpretation performed with a supervised classification method is then generally more geologically realistic than an electrofacies interpretation performed with an unsupervised classification method because it takes account of a pre-interpretation performed by a specialist.

An example of a fully automated electrofacies interpretation method is described in the document (Emelyanova et al., 2017). The method described in this document combines three unsupervised classification methods for finding a consensus classification. In other words, the method described in this document applies three unsupervised automatic classification methods to well log data in order to determine three electrofacies interpretations, and it determines a final electrofacies interpretation from these interpretations by majority vote. Moreover, the prediction quality is quantified by the proportion of majority votes relative to the total number of votes. However, this document does not describe the consideration of a criterion, which may be geological, for determining its final interpretation. In addition, the method described in this document does not yet propose to improve its final interpretation.

The document (Halotel et al., 2020) describes the relevance of accounting for information of geological type in supervised classification methods to improve the facies interpretation of well log data, compared to classification methods that would be driven by data only (data-driven classifiers). More precisely, this document describes constraints based on advanced prior analyses, such as an analysis of stratigraphic cycles, of (marine or non marine) deposit types, or petrophysical analyses for determining grain size, pore size, clay content, etc. Now, at least one of these geological and petrophysical analyses require a certain expertise (of a sedimentologist and a petrophysicist respectively) and they are generally very rarely available at the time of the electrofacies interpretation of log data. Furthermore, the method described in this document does not propose to refine the electrofacies interpretation resulting from a first classification, or to combine various classification methods for reaching a consensus classification.

Moreover, the document (Jeong et al., 2020) describes the combination of an unsupervised automatic core image classification method and of a supervised well log data classification method through a multi-layer neural network for an improved automatic lithofacies classification. More precisely, the method described in this document uses a classification obtained with an unsupervised classification method applied to core images in order to create learning information intended for a supervised classification method applied to log data. Thus, in this method, the learning information is obtained only from the well portions for which cores and, more than that, core images are available. In practice, cores are not available over the entire well length for which log records are available. Besides, the cores are taken in preferential zones of the well (in other words, they are not taken randomly). For example, in contrast to reservoir zones, clay cap zones are rarely or uncommonly cored (because their petrophysical properties are less sought after). Thus, the learning information described in this document is not necessarily representative of all the electrofacies classes present in the well, which may harm the result of the supervised classification subsequently implemented. Notably, the supervised classification result is de facto limited by the number of classes resulting from the unsupervised classification, which may lead to an erroneous electrofacies interpretation of the well log data. Moreover, the method described in this document uses a single supervised classification method, namely a multi-layer neural network, to determine the lithofacies at all depths, including non-cored depths. Thus, this document does not teach to combine different supervised classification methods in order to reach a consensus classification.

The document (Dubois et al., 2007) compares four supervised conventional log data classification methods with the same data set. However, the method described in this document does not describe the use of a criterion, which may be of geological type, to refine a classification. In addition, the method described in this document does not propose to refine the electrofacies interpretation resulting from a first classification or to combine different classification methods in order to reach a consensus classification. Finally, this document does not describe the quantification of the probability for a point to belong to a given class.

US published patent application 2002/0052,690 describes the application of supervised classification methods to determine a log data electrofacies interpretation. Moreover, this document describes a quantification of the probability for a point to belong to a class. However, this document does not describe the consideration of any criterion, which may be of geological type, to refine a classification. Furthermore, the method described in this document does not propose to refine the electrofacies interpretation resulting from a first classification, or to combine various classification methods so as to reach a consensus classification.

Thus, the methods described in the prior art describe either methods that can be fully automated but may lead to non geologically plausible or erroneous electrofacies interpretations, or partly automated methods requiring the creation of learning information by an expert, which leads to a more realistic but subjective electrofacies interpretation.

### SUMMARY OF THE INVENTION

The present invention overcomes these drawbacks. Notably, the method according to the invention allows elimination of the need for an electrofacies interpretation manually performed by an expert, which is a long and tedious process, for training automatic classification methods.

On the contrary, the method according to the invention can be fully automated. Notably, the method according to the invention allows automatic generation of learning information, selected from among a plurality of predictions, based on criteria that may be of geological type. In addition, the method according to the invention relies on the association of several learning algorithms to obtain better predictive performances, as well as quantification of the prediction quality.

The invention concerns a method for determining an electrofacies interpretation of measurements relative to at least a portion of at least one well drilled through an underground formation.

The method according to the invention comprises at least the following steps:
A) carrying out measurements relative to at least the portion of the at least one well drilled through the underground formation, the measurements resulting at least from at least one of well log and an image of at least one core sample taken in the at least one well;
B) applying a first f classification methods to the measurements relative to at least the portion of the at least one well, and determining first electrofacies classifications of the measurements relative to at least the portion of the at least one well, the classification methods being unsupervised classification methods, or, if learning information is available for at least one subset of the measurements relative to at least the portion of the at least one well, supervised classification methods trained on the learning information;
C) among the first electrofacies classifications of the measurements relative to at least the portion of the at least one well, selecting a reference electrofacies classification according to a predefined criterion, and selecting a portion of the reference electrofacies classification;
D) applying second classification method to the measurements relative to at least the portion of the at least one well, and determining second electrofacies classifications of the measurements relative to at least the portion of the at least one well, the classification methods being supervised classification methods trained on the portion of the reference electrofacies classification; and
E) determining the electrofacies interpretation of the measurements relative to at least the portion of the at least one well from the second plurality of electrofacies classifications of the measurements relative to at least the portion of the at least one well, the determination being performed using an ensemble learning method.

According to an embodiment of the invention, the at least one well log can be selected from among gamma ray logs, sonic logs, density logs, electric logs or well image logs.

According to an implementation of the invention, the unsupervised classification methods can comprise at least five types of unsupervised classification methods, and preferably eight types of unsupervised classification methods.

According to an implementation of the invention, at least one unsupervised classification method of the first unsupervised classification methods can be selected from among the following list: a model-based data clustering method, a fuzzy clustering method, a hierarchical k-means clustering method, and a density-based clustering method.

According to an implementation of the invention, at least one of the first and second supervised classification methods can comprise at least five types of supervised classification methods with preferably there being eight types of supervised classification methods.

According to an implementation of the invention, at least one supervised classification method of said the at least one of the first and second supervised classification methods can be selected from among the following list: a decision tree-based classification and regression, a random forest type classification, support vector machines, a bagged decision tree model, linear discriminant analysis, a mixture discriminant analysis, and a k-nearest neighbour method.

According to an implementation of the invention, the selection of the reference electrofacies classification according to a predefined criterion can select the classification of the first electrofacies classifications exhibiting at least the least class changes along at least the portion of the at least one well.

According to an implementation of the invention, in step A, measurements can be carried out for at least one of an additional well and for at least an additional portion of the well, steps B and C can be applied only to the portion of the well, and steps D and E can be applied to the portion of the well, to at least one of an additional well and the additional portion of the additional well.

According to an implementation of the invention, the portion of the reference electrofacies classification can comprise between 20% and 30% of the samples of the reference electrofacies classification.

According to an implementation of the invention, the samples of the portion of the reference electrofacies classification can be randomly selected.

According to an implementation of the invention, the ensemble learning method can be the majority voting method.

The invention further relates to a method of exploiting a fluid present in an underground formation, comprising implementing the method of determining an electrofacies interpretation of measurements relative to at least a portion of at least one well drilled through an underground formation as described above.

According to an implementation of the invention, from at least the electrofacies interpretation of measurements relative to at least the portion of the at least one well drilled through the underground formation, a grid representation representative of the underground formation can be constructed, at least one exploitation scheme for the fluid present in the underground formation can be determined from at least the grid representation representative of the underground formation, and the fluid of the underground formation can be exploited according to the exploitation scheme.

According to an implementation of the invention, the exploitation scheme of the fluid can comprise at least one site for at least one injection well and/or at least one production well, and the wells of the site can be drilled and equipped with production infrastructures.

### BRIEF DESCRIPTION OF THE DRAWINGS

Other features and advantages of the invention will be clear from reading the description hereafter of embodiments given by way of non-limitative example, with reference to the accompanying figures, wherein:

FIG. 1A shows a well log record of natural radioactivity type and an electrofacies interpretation manually made by a specialist for an example of application of the method according to the invention;

FIG. 1B shows an electrofacies interpretation and its associated uncertainties, determined by an implementation of the method according to the invention applied to the application example of FIG. 1A; and

FIG. 2 shows an electrofacies interpretation and its associated uncertainties, determined by a method according to the prior art applied to the application example of FIG. 1A.

### DETAILED DESCRIPTION OF THE INVENTION

According to a first aspect, the invention concerns a method for determining an electrofacies interpretation of measurements relative to at least a portion of at least one well drilled through an underground formation.

According to a second aspect, the invention concerns a method of exploiting a fluid present in an underground formation, the method according to the second aspect comprising implementing the method of determining an electrofacies interpretation of measurements relative to at least a portion of at least one well according to the first aspect of the invention.

According to the invention, the measurements relative to at least a portion of at least one well result at least from at least one of a well log and from an image of at least one core sample taken in the well considered, in the at least one well portion considered.

According to an implementation of the invention, the underground formation of interest can comprise a petroleum reservoir, preferably including its cap rock.

According to the invention, the well traversing the underground formation of interest can have any geometry which may notably be a vertical or a deflected well. Reference then will be to well trajectory.

Electrofacies are understood to be the grouping of samples from the plurality of measurements (well logs for example) having homogeneous (measurement) values. In other words, two measurement (well log) samples belong to the same group, or electrofacies, if their (for example log) responses, that is if the (log) measurements performed at these points, are not substantially different. The notion of electrofacies was notably introduced in the document (Serra and Abbot, 1980). The determination of different electrofacies can be viewed as the search for both maximization of the differences between (for example log) responses at any two points belonging to two different electrofacies, and minimization of the differences between (for example log) responses of any two points belonging to the same electrofacies.

Electrofacies interpretation of measurements relative to a well is understood to be an electrofacies classification (or clustering) of the samples located along the well trajectory for which measurements are available. In other words, after an electrofacies interpretation, a class is assigned to each sample along the well trajectory for which measurements are available. An electrofacies class is a label or tag, which may be any non-significant (class “C0”, class “C1” for example) or significant (“sandstone”, “clay”, “limestone” for example) character string, a color or simply a symbol (*, +, % for example), etc. This label or tag is not a quantitative value, in contrast to quantities such as numbers following an order relation (that is inferiority, superiority, equality). In particular, when an electrofacies interpretation performed by a specialist is available, at least for some samples along at least a portion of at least one well, an electrofacies class can be a character string representative of a lithologic type (for example “sandstone”, “clay”, “limestone”, etc.). One speaks then of lithofacies.

In general terms, the method according to the invention comprises at least the following steps:
1. Acquisition of measurements relative to at least a portion of at least one well
2. Application of supervised or unsupervised classification methods
3. Selection of a reference electrofacies classification
4. Application of supervised classification methods
5. Determination of the electrofacies interpretation
6. Exploitation of a fluid present in the underground formation.

The method according to the first aspect of the invention comprises at least steps 1 to 5 described hereafter.

The method according to the second aspect of the invention further comprises at least step 6 described hereafter.

Steps 2 to 5 can be carried out using information technologies, notably a computer.

The different steps of the method according to the invention are detailed hereafter.

According to the invention, the steps of the method of the invention are applied to at least a portion of at least one well drilled through the underground formation. According to an implementation of the invention, steps 1, 4 and 5 can further be applied to another well drilled through the underground formation of at least one of interest and to another portion of the well (other intervals along the well trajectory for example) for which steps 2 and 3 have been applied. Thus, as described hereafter, the learning information determined for at least a portion of at least one well can be exploited after steps 2 and 3 for other portions of the well and/or other wells.

1. Acquisition of Measurements Relative to a Well

This step consists in carrying out a plurality of measurements relative to at least a portion of at least one well drilled through the underground formation of interest, the measurements resulting from at least one of a well log and an image of at least one core sample taken in the well being considered.

According to an implementation of the invention, the at least one well log can be selected from among gamma ray logs, sonic logs, density logs, electric logs or well wall image logs. Advantageously, at least five different logs are achieved for a single portion of a well. The multiplicity of the different log types enables more reliable electrofacies interpretation, by redundancy of the information that can be deduced from each log type.

As is well known, acquisition of a well log is achieved using a sonde that moves along the well trajectory (at least a portion, typically a few kilometers) and measures a property (for example density, natural radioactivity, resistivity, etc.) of the rock surrounding the well for a succession of sampling intervals (of the order of ten cm). Thus, a log measurement results in a series of samples (typically ranging from a few thousand to about ten thousand measurement points) along the considered well trajectory, each sample comprising at least one value of a property (for example density, natural radioactivity, resistivity, etc.) of the surrounding rock.

According to an implementation of the invention, well logs may undergo preprocessing, such as resampling, as it is well known to the person skilled in the art, so that well logs of different types are “repositioned” at the same measurement points along the well trajectory.

According to the invention, the at least one image of at least one core taken in at least one well is obtained using an imaging device, for example scan imaging or any other imaging technique. Preferably, the core sample image can be preprocessed, using texture analysis for example, to determine at least one measurement of a property (bed dip for example) sought for a series of samples along the well trajectory. Advantageously, when a core image is used in combination with at least one well log, resampling may be performed so that the series of samples of the core images and of the well log are consistent in terms of measurement point location. Information on core image processing methods can be found in the document (Jeong et al., 2020) for example.

At least two types of measurements performed in a well are obtained at the end of this step, i.e. measurements from at least one of a well log and a core image, for a succession of samples along at least a portion of the trajectory of at least one well drilled through the underground formation of interest.

2. Application of Supervised or Unsupervised Classification Methods

This step applies supervised or unsupervised classification methods to the measurements relative to at least a portion of at least one well obtained in the previous step, in order to determine electrofacies classifications of the measurements. According to the invention, applying supervised classification methods requires learning information for a subset of the at least portion of the at least one well.

According to an implementation of the invention, even if measurements have been performed at least on wells and several portions of a well in step 1, this step can be implemented for at least a portion of at least one well.

The two main variants of the method according to the invention are detailed hereafter, using either supervised classification methods (first variant), or a plurality of unsupervised classification methods (second variant).

2.1 First Variant: Application of a Plurality of Supervised Classification Methods

In general terms, a supervised classification method is a method for grouping samples into homogeneous and distinct classes by accounting for predefined classification rules (or of a model) determined from learning information. One can then also speak of training a supervised classification method using learning information.

The learning information according to this variant of the invention is a prior identification of classes (for example performed manually by a specialist or using any other method, notably any automatic method) for at least one subset (or part, or portion) of samples to be classified by the supervised classification method. For example, a geoscience specialist may have identified, from a manual log analysis, distinct classes and determined classes for at least one subset of the samples. Conventionally, if this learning information is manually constructed by a specialist, it can represent about 10% of the samples to be classified. Indeed, a manual interpretation of conventional well logs (comprising thousands to ten thousand samples) is often long and tedious, and it is not realistic to manually obtain an identification of a class for each sample to be classified.

In general, a supervised classification method does not require specifying a number of classes into which the samples should be grouped. Instead, the number of classes determined by a specialist is based on the samples considered for constructing the learning information.

According to this variant of the invention wherein the current step is applied using supervised classification methods, at least two supervised classification methods, preferably at least five supervised classification methods and more preferably at least eight supervised classification methods are applied in this step. It is clear that the supervised classification methods mentioned here are of different types. The larger the number of supervised classification methods (types) applied in this step, the more reliable the electrofacies classification obtained at the end of the method according to the first variant of the invention.

According to an implementation of this variant of the invention, at least one of the supervised classification methods applied in this step can be selected from among the following methods: decision tree-based classification and regression (CART), random forest type classification or its parallel random forest variant, support vector machines, bagged decision tree model (bagged CART), linear discriminant analysis or its variant referred to as mixture discriminant analysis, k-nearest neighbour method. A description of these methods can for example be found in the document (Gan et al., 2007).

Preferably, in this step, at least a classification of decision tree forest type, also referred to as random forest, and of bagged decision tree (bagged CART) type can be applied. Indeed, these two methods are amongst the most efficient for supervised classification, notably for measurements performed in a well, such as well logs and/or core images.

A description of the random forest method can be found for example in the document (Ho, 1995). The random forest method is a machine learning method that randomly combines a large number of decision trees. Two randomness types are introduced. On the one hand, each decision tree is constructed on a random sample from the original data. On the other hand, at each decision tree node, a subset of features (i.e. at least one of the different types of well logs and core images for applying the method according to the invention) is randomly selected to generate the best distribution. The input data is the measurements (logs and/or core images) relative to at least the portion of the at least one well and the number of classes that are selected. The membership class is obtained for each sample at the output. In addition to its performances, the other attractiveness of this method lies in the reduced number of automatically adjusted parameters, 2 here, i.e. the number of decision trees and the number of features to be selected at each decision tree node to generate the best distribution.

A description of the bagged decision tree method (Bagged CART: Classification And Regression Trees) can for example be found in the document (Genuer and Poggi, 2018). The bagged decision tree method involves, like the random forest method, decision trees. This method is additionally based on bagging, which is a specific case of average model calculation methods. The input data is the measurements (at least one of the log data and core images) relative to at least the portion of the at least one well being considered and of the number of classes selected. The membership class is obtained for each sample at the output. Unlike the random forest method, a single parameter is automatically adjusted, namely the number of decision trees.

2.2 Second Variant: Application of Unsupervised Classification Methods

In general terms, an unsupervised classification method is a method of clustering or segmenting a set of samples into homogeneous and distinct classes. It is referred to as clustering or labeling. Unlike a supervised classification method, an unsupervised classification method is not trained by learning information.

Conventionally, an unsupervised classification method requires a number of classes as the input. Advantageously, the number of classes at the input of the unsupervised classification methods is at least five, preferably ten. The larger the number of classes, the more detailed the electrofacies classification. The person skilled in the art knows how to select a suitable number of classes for characterization of a particular underground formation.

According to this variant of the invention wherein the current step is applied using unsupervised classification methods, at least two unsupervised classification methods, which is preferably at least four unsupervised classification methods and more preferably at least six unsupervised classification methods are applied. It is clear that the unsupervised classification methods mentioned here are of different types. The larger the number of unsupervised classification methods (types) applied in this step, the more reliable the electrofacies classification at the end of the method according to the first aspect of the invention.

According to an implementation of this variant of the invention, at least one of the unsupervised classification methods applied in this step can be selected from among the model-based clustering method, the fuzzy clustering method, the hierarchical k-means clustering method, the density-based clustering method, the spectral clustering method or the self-organizing map method.

Preferably, in this step, at least one of the model-based clustering method and the fuzzy clustering method can be applied. These two methods indeed appear to be the most efficient for automatic classification, notably for measurements of at least one of well log and core image type.

A description of the fuzzy clustering method can be found for example in the document (Dunn, 1973). At the end of a conventional data clustering method, the membership of each sample to a given class is known. In fuzzy data clustering, membership of a sample to a class is less rigid. More precisely, a number ranging between 0 and 1 is associated with each sample for each class. The closer this number to 1 (respectively 0), the closer (respectively the further) the sample is to (from) the center of the cluster corresponding to the class considered. Thus, this number quantifies in a certain way the membership degree of the sample to the class considered. The input data is the measurements performed in step 1 (at least one of log data and core images) and the number of classes selected. The vector of the degrees of membership to each class is deduced for each sample at the output. The class selected for the sample is that for which the membership degree is the highest.

A description of the model-based clustering method can be found for example in the document (Fraley and Raftery, 2002). For this method, membership of a sample to a class is also not rigid, as in the fuzzy clustering method. However, unlike the latter, a real statistical model is used in the model-based clustering method. More precisely, a probability of belonging to a class is associated with each sample. Thus, in practice, each sample is considered to result from a distribution that is a mixture of two or more components. Each component (or class) is associated with a cluster. It is described by a probability density function and it has an associated weight in this mixture. This function, which could be arbitrarily selected, is chosen for simplicity in form of a multivariate normal Gaussian distribution function. The input data is the measurements (log data and core images) relative to at least the portion of the at least one well considered and the number of classes selected. The probability of belonging to each class for each sample is deduced at the output. The class selected for the sample is that for which the membership probability is the highest.

Thus, at the end of this step, a class is obtained for each sample of the measurements performed along at least a portion of at least one well drilled through the underground formation of interest, for each classification method, at least one of supervised or unsupervised, is applied to the log data and the well images. In other words, at the end of this step, electrofacies classifications is obtained, more specifically, an electrofacies classification for each classification method, supervised or unsupervised, applied. One will speak hereafter of “first plurality of electrofacies classifications” of the measurements performed in at least a portion of at least one well. One could also speak of a “first plurality of intermediate electrofacies interpretations”, a (final) electrofacies interpretation being the goal of the method according to the first aspect of the invention, obtained after step 5 described below.

3. Selection of a Reference Electrofacies Classification

This step selects, among the first electrofacies classifications obtained in the previous step, an electrofacies classification that is referred to hereafter as “reference electrofacies classification”, and in selecting a portion of this reference electrofacies classification. A “classification portion” is understood to be a subset of the samples of at least a portion of at least one well for which an electrofacies classification has been determined in step 2.

According to the invention, selection of a reference electrofacies classification is made among the first electrofacies classifications according to a predefined criterion.

According to an implementation of the invention, selection of a reference electrofacies classification according to a predefined criterion can be a selection, from among the first of the electrofacies classifications from the previous step, that for which at least the number of class changes along at least a portion of the at least one well is the smallest. In other words, the most stable electrofacies classification along the well is sought. This reflects the geological reality which is the properties of the rocks that make up an underground formation are globally stable over intervals corresponding to the same sedimentary deposits.

Furthermore, according to the invention, a portion of the reference electrofacies classification is selected, which is a portion of the reference electrofacies classification samples. According to an implementation of the invention, between 10% and 40% of the reference electrofacies classification samples, preferably between 20% and 30%, are selected. The number of reference electrofacies classification samples selected is used in the next step as learning information for an application of supervised classification methods. The number of samples selected must allow these supervised classification methods the flexibility to depart from this model while being guided by this learning information. This goal is reached in particular with a number of samples ranging between 20% and 30%.

Preferably, selection of a portion of the reference electrofacies classification samples is randomly performed. Indeed, it is thus more likely to sample all of the reference electrofacies classification classes because, on the contrary, the reference electrofacies classification is not randomly organized.

Thus, at this end of this step, learning information intended to be used in the rest of the method according to the invention is obtained. This learning information was not set up manually by a specialist, but fully automatically. This learning information may also have been determined using a criterion based on geological considerations, so that the learning information is geologically plausible.

4. Application of a Plurality of Supervised Classification Methods

This step applies supervised classification methods to measurements relative to at least a portion of at least one well from step 1 in order to determine second electrofacies classifications of these measurements with the supervised classification methods being trained over the portion of reference electrofacies classification samples selected in the previous step as learning information. What we are referring to here are second electrofacies classifications, as first electrofacies classifications was obtained at the end of step 2 described above. This may be described as “second intermediate electrofacies interpretations” with a “final” electrofacies interpretation being the goal of the method according to the first aspect of the invention, obtained at the end of step 5 described below.

The principle of supervised classification methods is described in general terms in section 2.1 above.

Advantageously, the supervised classification methods can be trained on additional logging measurements performed at the same measurement points as those considered in steps 2 to 3 to construct learning information. Including additional well log types tends to improve the supervised learning process.

According to the invention, this step is applied to at least two supervised classification methods, preferably at least five supervised classification methods, and more preferably at least eight supervised classification methods. It is clear that the supervised classification methods mentioned here are all of different types. The larger the number of supervised classification methods (types), the more reliable the electrofacies interpretation is obtained at the end of the method according to the first aspect of the invention.

According to an implementation of the first variant of the invention wherein step 2 is carried out using supervised classification methods, the supervised classification methods carried out in step 4 can be different from those carried out in step 2. According to this variant, or identical. In any case, the result will be different because these (first and second) supervised classification methods are applied from different learning information.

According to an implementation of the invention, at least one of the supervised classification methods applied in this step can be selected from among the following methods: decision tree-based classification and regression (CART), random forest type classification or its parallel random forest variant, support vector machines, bagged decision tree model (bagged CART), linear discriminant analysis or its variant referred to as mixture discriminant analysis, k-nearest neighbour method. A description of these methods can for example be found in Gan et al., 2007.

Preferably, in this step, at least a classification of decision tree forest type, also referred to as random forest, and a bagged decision tree model (bagged CART) can be applied. Indeed, these two methods are amongst the most efficient for supervised classification, notably for well logs and/or core images. A description of these methods can be found in section 2.1 above.

According to an implementation of the invention, the supervised classification methods can further be applied to measurements relative to another well portion than that used for applying steps 2 to 3 above, or to other wells drilled through the underground formation of interest. Thus, the learning achieved for at least a portion of at least one well drilled through the underground formation is used for electrofacies classification of other well portions or of other wells for which measurements are available. It is clear that good results can only be obtained for this implementation of the invention if the samples selected in step 3 for learning of the second supervised classification methods in step 4 are sufficiently representative of the other wells or of the other portions of the same well.

Thus, at the end of this step, a class is obtained for each sample of the measurements performed along at least a portion of at least one well drilled through the underground formation of interest, for each supervised classification method applied to at least one of the well logs and well images. In other words, at the end of this step, second electrofacies classifications are obtained. More precisely, an electrofacies classification is obtained for each supervised classification method applied using the learning information automatically determined in step 3. It may also be referred to as “second intermediate electrofacies interpretations”.

5. Determination of the Electrofacies Interpretation

This step determines an electrofacies interpretation representative of at least the portion of the at least one well from the second electrofacies classifications of the measurements performed for at least a portion of at least one well with determination being performed by an ensemble learning method. In other words, the final electrofacies interpretation of at least a portion of at least one well is determined here from the second intermediate electrofacies interpretations obtained in step 4, itself obtained from the first intermediate electrofacies interpretations obtained in step 2.

In general terms, ensemble learning methods are conventionally used to obtain better predictive performances, by combining several learning algorithms. In general, an ensemble classification method allows construction of a “synthesis” classification that somehow takes the best of each classification. It may also be referred to as “consensus classification”.

According to an implementation of the invention, an ensemble learning method is selected from among the following methods: majority voting, boosting, bootstrap aggregating or bagging, Bayes optimal classifier, stacking or bucket of models. A description of these methods can be found in Seni and Eleder, 2010 for example.

Advantageously, uncertainties related to each sample of the electrofacies interpretation determined in this step can further be determined. It can be stated the probability of belonging to a class (which is then the inverse of uncertainty). Determination of the uncertainties related to an electrofacies interpretation can allow highlighting of portions of the electrofacies interpretation for which a posteriori control is not necessary (portions for which uncertainties are low, less than 0.5 for example) and, on the other hand, to highlight portions of the electrofacies interpretation for which revision or at least control (by using any automatic method or through the intervention of an expert) of the interpretation is recommended (portions for which uncertainties are high, greater than 0.5 for example). For example, it can be considered that learning information is constructed from the final electrofacies interpretation corrected by a manual interpretation performed by a specialist at least in the electrofacies interpretation portions for which uncertainties are high, prior to relaunching at least one supervised classification method. A description of methods for determining uncertainties related to a classification resulting from an ensemble classification method can be found in Niculescu-Mizil & Caruana, 2005 for example.

According to an implementation of the invention, the majority voting method can be used as the ensemble learning method. This method has the advantage of being easy to implement. It proceeds sample by sample and selects, for a given sample, from among all the classes predicted by each classification method, the majority class. Since this method proceeds sample by sample, it also has the advantage of providing direct determination of the samples for which the uncertainty is low (if a large number of classification methods has predicted the same class) and, on the other hand, the samples for which the uncertainty is high (if a large number of classification methods predict different classes).

Thus, at the end of this last step of the method according to the first aspect of the invention, an electrofacies interpretation of the measurements performed for at least a portion of at least one well is obtained using a method that can be fully automated (at least by using the first variant of step 2). In particular, the method according to the invention allows, without an electrofacies interpretation, manual performance by an expert, which is a long and tedious process, for training automatic classification methods.

Indeed, the method according to the invention allows automatic generation learning information selected from predictions, based on criteria that can be geological. In addition, the method according to the invention relies on the combination of several learning algorithms in order to obtain better predictive performances, and a potential quantification of the prediction quality.

6. Exploitation of a Fluid Present in the Underground Formation

This step is carried out in the context of the method according to a second aspect of the invention, which concerns a method for exploiting a fluid present in the underground formation being studied. The fluid of interest can comprise hydrocarbons which are at least one of an oil phase and a gas phase.

In this step of the method according to the second aspect of the invention, a fluid contained in the underground formation is exploited from at least the electrofacies interpretation of at least a portion of at least one well determined at the end of the previous step.

According to an implementation of the invention, from at least the electrofacies interpretation of at least a portion of at least one well, it is possible to determine a grid representation representative of the underground formation of interest and to determine at least one exploitation scheme for the fluid contained in the underground formation from this grid representation. Then the fluid of interest is exploited according to the exploitation scheme.

Conventionally, a grid representation representative of an underground formation of interest constructed, as according to the invention, from at least the electrofacies interpretation of at least a portion of at least one well, but it is also advantageously constructed from measurements performed on rock samples taken in wells including information deduced from seismic acquisition surveys, production data such as oil flow rate, water flow rate, pressure variations, etc. Persons skilled in the art are fully aware of methods for constructing a grid representation representative of an underground formation.

A particular implementation of the invention wherein the fluid comprises hydrocarbons is described hereafter by way of non-limitative example. Generally, in petroleum exploitation, an exploitation scheme comprises a number, a geometry and a site (position and spacing) for the injection and production wells to be drilled through the reservoir being studied and to be equipped. An exploitation scheme can further comprise a type of enhanced recovery of the hydrocarbons contained in the reservoir, such as recovery through injection of a solution containing one or more polymers, CO2 foam, etc. An optimum hydrocarbon reservoir exploitation scheme must for example allow having a high recovery rate for the hydrocarbons trapped in the geological reservoir, over a long exploitation time, and require a limited number of wells. In other words, the specialist predefines evaluation criteria according to which a geological reservoir fluid exploitation scheme is considered to be efficient enough to be implemented for the geological reservoir being studied.

According to an implementation of the invention, determination of an exploitation scheme for the hydrocarbons of the geological reservoir studied can be achieved using a flow simulator (or reservoir simulator). An example of such a reservoir simulator is the PumaFlow® (IFP Energies nouvelles, France) simulator. In general, at any time t of the simulation, a flow simulator solves all of the flow equations specific to each cell and it delivers a values solution to the unknowns (saturations, pressures, concentrations, temperature, etc.) predicted at this time t. This solution provides knowledge of the amounts of oil produced and of the state of the reservoir (pressure distribution, saturations, etc.) at the time being considered. By using a grid representation, determined from at least one electrofacies interpretation for at least a portion of at least one well, the flow simulator allows a reliably prediction notably of the oil and gas productions for a given exploitation scheme.

According to an implementation of the invention, various exploitation schemes can be defined for the fluid contained in the geological reservoir being studied, and at least one criterion, such as the amount of hydrocarbons produced with each of the various exploitation schemes, the curve representative of the production evolution over time in each well, the gas-oil ratio (GOR), etc., is estimated using the flow simulator. The scheme according to which the hydrocarbons contained in the reservoir are really exploited can then correspond to the one meeting at least one of the evaluation criteria of the various exploitation schemes. According to the invention, flow simulations are performed for injection-production well sites using the simulator according to the invention and by using a grid representation determined from at least one electrofacies interpretation for at least a portion of at least one well, then the exploitation scheme according to which the fluid of the geological reservoir is to be exploited for each well site is determined, and the site meeting at least one of the predetermined evaluation criteria is selected. Advantageously, flow simulations can further be carried out for enhanced recovery types, by use of the simulator according to the invention and of a grid representation determined from at least one electrofacies interpretation of at least a portion of at least one well, then the exploitation scheme according to which the fluid of the geological reservoir is to be exploited for each enhanced recovery type is determined, and the enhanced recovery method meeting at least one of the predetermined evaluation criteria is selected.

Then, once the exploitation scheme is determined, the hydrocarbons trapped in the oil reservoir are exploited according to this exploitation scheme, notably at least by drilling the injection and production wells of the exploitation scheme thus determined, to produce the hydrocarbons, and by setting up the production infrastructures required for developing this reservoir. In cases where the exploitation scheme was further determined by estimating the reservoir production associated with different enhanced recovery types, the type(s) of additives (polymer, surfactant, CO2 foam) selected as described above are injected into the injection well.

The exploitation scheme can of course keep developing over the duration of an exploitation of hydrocarbons of a geological reservoir, depending on the reservoir knowledge acquired during exploitation, improvements in the various technical fields involved in the exploitation of a hydrocarbon reservoir (improvements in the field of drilling, enhanced recovery for example).

### APPLICATION EXAMPLE

The advantages of the method according to the invention are presented hereafter in an application example.

This application example uses well log data measured in a portion from about 1800 m to 3300 m deep of a vertical well drilled through an underground formation comprising mainly sandstones and clays, offshore Western Australia. A description of this log data can be found in Emelyanova et al., 2017.

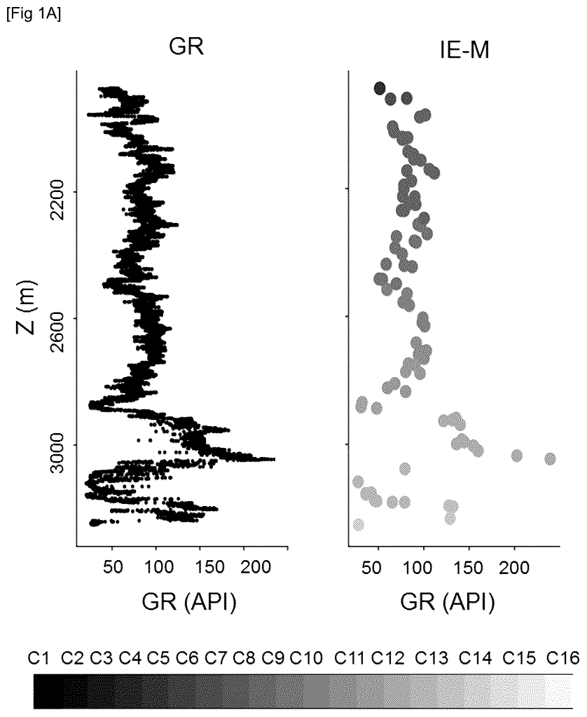

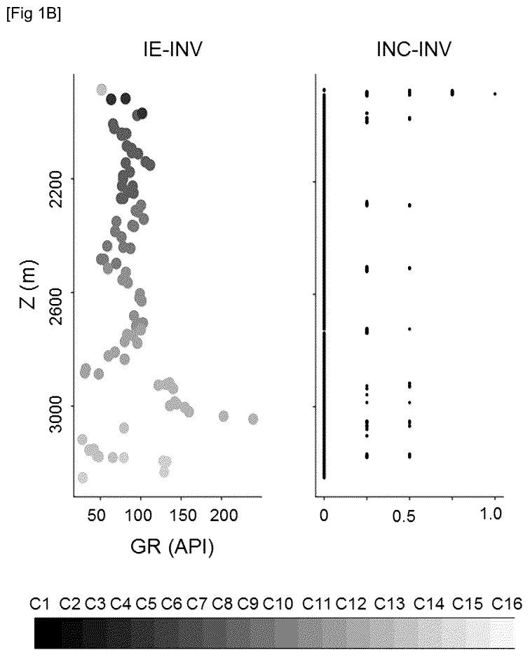

There are five types of well logs, namely natural radioactivity in gamma ray GR logs, a sonic log, a density log, a neutron log and electric logs. FIG. 1A on the left shows by way of illustration a GR natural radioactivity log (in API units, conventionally used in this field) as a function of depth Z.

The method according to the first aspect of the invention is implemented here by the second variant of step 2, with unsupervised classification methods for automatic determination of learning information, which more precisely is 8 unsupervised classification methods in this case. Furthermore, the criterion chosen for selecting the reference electrofacies classification is the one based on the classification with the lowest number of class changes as a function of depth. In addition, 8 supervised classification methods were used for step 5, with the majority voting method as the ensemble classification method to determine the final electrofacies interpretation.

FIG. 1B on the left shows by way of illustration the electrofacies interpretation IE-INV resulting from the implementation of the method according to the first aspect of the invention. More precisely, for this figure, the classes determined with the method according to the invention along the well (the interpretation result is given here only for one sample out of ten along the well, for viewing purposes) are indicated by colors in a range of shades of grey, and they are placed on the x-axis (for illustration purposes) at the level of the value corresponding to the GR log. It is observed that the electrofacies interpretation obtained with the method according to the invention results in 16 distinct classes, denoted by C1 to C16 here. It is also noted that the classes which are determined with the method according to the invention are geologically plausible, insofar as class stability with depth can be observed, despite the fully automated character of the method according to the invention.

By way of comparison, FIG. 1A on the right illustrates (with the same representation conventions as for curve IE-INV) an electrofacies interpretation IE-M manually performed by an expert geologist (which is exceptional with such a large number of measurement points). A very good agreement can be observed between the fully automated electrofacies interpretation performed with the method according to the invention and the manual interpretation. However, the fully automated electrofacies interpretation performed with the method according to the invention can be obtained in about ten minutes with a processor of Intel Xeon CPU E5-1620 v3 @ 3.50 GHz type, whereas the manual interpretation performed by the expert can take several days.

FIG. 1B on the right shows the uncertainties INC-INV between 0 (reliable classification) and 1 (unreliable classification) associated with the electrofacies interpretation IE-INV obtained with the method according to the invention. It is noted that the rare levels where the classification deduced by the method according to the invention and that of the expert differ conventionally correspond to the levels where the associated uncertainty is less than or equal to 0.6, that is in the case of not very reliable to an unreliable classification. Thus, determination of the uncertainties associated with the electrofacies interpretation can allow detecting zones where an expert's contribution is recommended or even essential. On the other hand, for zones where uncertainties are low, this can mean that it is not necessary for an expert to intervene manually in order to complete the electrofacies interpretation automatically determined by the method according to the invention.

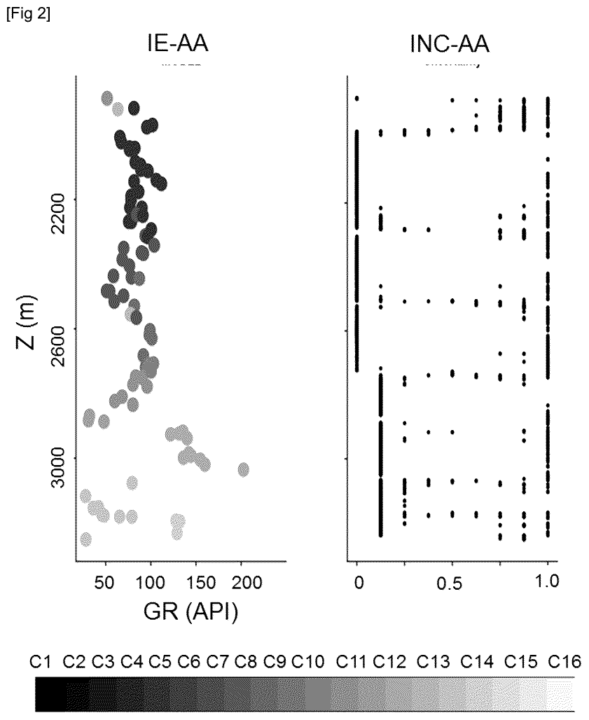

By way of comparison, FIG. 2 on the left illustrates (with the same representation conventions as for curve IE-INV) an electrofacies interpretation IE-AA determined with a method according to the prior art, more precisely the model-based clustering method based on a Gaussian mixture model (see for example Fraley and Raftery, 2002; Fraley et al., 2012), and its associated uncertainties INC-AA in FIG. 2 on the right. A slightly lower quality in the automatic prediction of the method according to the prior art IE-AA can be observed compared to the predictions of the method according to the invention IE-INV, especially strong uncertainties associated with zones for which the uncertainties obtained with the method according to the invention are however low.

Thus, the method according to the invention provides a reliable and fast electrofacies interpretation that can be fully automated. Furthermore, the method according to the invention can allow determination of uncertainties enabling highlighting zones for which an interpretation or at least a manual control by an expert is desirable.

1-14. (canceled)

15. A method of determining an electrofacies interpretation of measurements relative to at least a portion of at least one well drilled through an underground formation, comprising steps of:
A) carrying out measurements relative to at least the portion of the at least one well drilled through the underground formation, the measurements resulting from at least one of a well log and an image of at least one core sample taken in the at least one well;
B) applying classification methods to the measurements relative to at least the portion of the at least one well and determining first electrofacies classifications of the measurements relative to at least the portion of the at least one well, the classification methods being unsupervised classification methods, or, if learning information is available for at least one subset of the measurements relative to at least the portion of the at least one well, supervised classification methods trained on the learning information;
C) among the first electrofacies classifications of the measurements relative to at least the portion of the at least one well, selecting a reference electrofacies classification according to a criterion, and selecting a portion of the reference first electrofacies classification;
D) applying second classification methods to the measurements relative to at least the portion of the at least one well and determining second electrofacies classifications of the measurements relative to at least the portion of the at least one well, the classification methods being supervised classification methods trained on the portion of the reference electrofacies classification; and
E) determining the electrofacies interpretation of the measurements relative to at least the portion of the at least one well from the second electrofacies classifications of the measurements relative to at least the portion of the at least one well, the determination being performed using an ensemble learning method.

16. A method as claimed in claim 15, wherein the at least one well log is selected from among gamma ray logs, sonic logs, density logs, electric logs or well image logs.

17. A method as claimed in claim 15, wherein the unsupervised classification methods comprise at least five types of unsupervised classification methods.

18. A method as claimed in claim 15, wherein at least one unsupervised classification method of the unsupervised classification methods is selected from a model-based data clustering method, a fuzzy clustering method, a hierarchical k-means clustering method, and a density-based clustering method.

19. A method as claimed in claim 15, wherein at least one of the first and second supervised classification methods comprises at least five types of supervised classification methods.

20. A method as claimed in claim 15, wherein at least one supervised classification method of at least one of the first and second supervised classification methods is selected from a decision tree-based classification and regression, a random forest type classification, support vector machines, a bagged decision tree model, a linear discriminant analysis, a mixture discriminant analysis, and a k-nearest neighbour method.

21. A method as claimed in claim 15, wherein the selection of the reference electrofacies classification according to a predefined criterion selects the classification of the first electrofacies classifications exhibiting at least changes along at least the portion of the at least one well.

22. A method as claimed in claim 15, wherein, in step A, measurements are carried out for at least one of an additional well and at least an additional portion of the well, and steps B and C are used only with a portion of the well, and steps D and E are applied to the portion of the well, and to at least one of the additional well and the additional portion of the well.

23. A method as claimed in claim 15, wherein the portion of the reference electrofacies classification comprises between 20% and 30% of the samples of the reference electrofacies classification.

24. A method as claimed in claim 23, wherein the samples of the portion of the reference electrofacies classification are randomly selected.

25. A method as claimed in claim 15, wherein the ensemble learning method is a majority voting method.

26. A method of exploiting a fluid present in an underground formation, comprising implementing the method of determining an electrofacies interpretation of measurements relative to at least a portion of at least one well drilled through an underground formation as claimed in claim 15.

27. A method as claimed in claim 26, wherein, from at least the electrofacies interpretation of measurements relative to at least the portion of the at least one well drilled through the underground formation, a grid representation representative of the underground formation is constructed, at least one exploitation scheme for the fluid present in the underground formation is determined from at least the grid representation representative of the underground formation, and the fluid of the underground formation is exploited according to the exploitation scheme.

28. A method as claimed in claim 26, wherein the exploitation scheme of the fluid comprises at least one site of at least one of an injection well and at least one production well, and the wells of the site are drilled and equipped with production infrastructures.

29. A method as claimed in claim 16, wherein at least one unsupervised classification method of the unsupervised classification methods is selected from a model-based data clustering method, a fuzzy clustering method, a hierarchical k-means clustering method, and a density-based clustering method.

30. A method as claimed in claim 17, wherein at least one unsupervised classification method of the unsupervised classification methods is selected from a model-based data clustering method, a fuzzy clustering method, a hierarchical k-means clustering method, and a density-based clustering method.

31. A method as claimed in claim 16, wherein at least one supervised classification method of at least one of the first and second supervised classification methods is selected from a decision tree-based classification and regression, a random forest type classification, support vector machines, a bagged decision tree model, a linear discriminant analysis, a mixture discriminant analysis, and a k-nearest neighbour method.

32. A method as claimed in claim 17, wherein at least one supervised classification method of at least one of the first and second supervised classification methods is selected from a decision tree-based classification and regression, a random forest type classification, support vector machines, a bagged decision tree model, a linear discriminant analysis, a mixture discriminant analysis, and a k-nearest neighbour method.

33. A method as claimed in claim 18, wherein at least one supervised classification method of at least one of the first and second supervised classification methods is selected from a decision tree-based classification and regression, a random forest type classification, support vector machines, a bagged decision tree model, a linear discriminant analysis, a mixture discriminant analysis, and a k-nearest neighbour method.

34. A method as claimed in claim 19, wherein at least one supervised classification method of at least one of the first and second supervised classification methods is selected from a decision tree-based classification and regression, a random forest type classification, support vector machines, a bagged decision tree model, a linear discriminant analysis, a mixture discriminant analysis, and a k-nearest neighbour method.
